(19) United States
(12) Patent Application Publication
(10) Pub. No.: US 2011/0159158 A1
(43) Pub. Date: Jun. 30, 2011

(54) REDUCED NON-FIBER CARBOHYDRATE PRESERVATIVE TREATMENT FOR PROCESSED FOODS

(76) Inventors: Ronald Penna, Los Angeles, CA (US); Michael Osborn, Los Angeles, CA (US); Andree Armand, Venice, CA (US)

(21) Appl. No.: 12/651,414

(22) Filed: Dec. 31, 2009

(51) Int. Cl. A23L 3/3454

(52) U.S. Cl. 426/321; 426/654

(57) ABSTRACT

The present invention is comprised of a process and multiple reduced non-fiber carbohydrate preservative treatment ingredients to control water activity (aw) in the processing of food components to extend shelf life of processed foods. The process includes formulating a specific combination of the multiple treatment ingredients to effectively produce a desired water activity (aw) level using measurements of water activity (aw) in the food components. The multiple treatment ingredients include using soluble fiber and salt to control water activity (aw) to extend shelf life and not significantly add to the non-fiber carbohydrate and calorie levels of the processed food product.

### BACKGROUND

The term processed foods includes a preservation treatment of the foods to extend the shelf life or time the product can be stored prior to use or consumption. The preservation treatment uses various additives to the original foods to control the water activity (aw) of the foods stored. Currently the control of water activity (aw) uses additives such as sugar, high fructose corn syrup, glycerin and brown rice syrup. The net result is that the processed foods have a higher level of carbohydrates due to the use of these additives.

### BRIEF DESCRIPTION OF THE DRAWINGS

FIG. 1 shows a block diagram of an overview of a reduced non-fiber carbohydrate preservative treatment process for processed food water activity control of one embodiment of the present invention.

FIG. 2A shows a flow chart of a reduced non-fiber carbohydrate preservative treatment process for food water activity control additive combination of one embodiment of the present invention.

FIG. 2B shows a flow chart of a reduced non-fiber carbohydrate preservative treatment process for food water activity control of one embodiment of the present invention.

FIG. 3 shows for illustrative purposes only shows an example of the reduced non-fiber carbohydrate preservative treatment process for processing nutrition/protein bars of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### GENERAL OVERVIEW

It should be noted that the descriptions that follow, for example, in terms of nutrition/protein bars are described for illustrative purposes and the underlying process can apply to any food components in a preservation process. In one embodiment of the present invention, the preservation process is used for the ingredients of nutrition/protein bars through the controlled treatment with natural additives that control the water activity (aw). The preservation process is adjustable and the amounts of additives and processes can be adjusted to result in the extension of shelf life of any processed food using the present invention.

### Preservation of Food:

The preservation of food for storage is a part of the history of the human race. Drying foods and packing foods in sugars and salts are processes thousands of years old. Even prehistoric humans knew that untreated foods would spoil in a very short time. Modern humans discovered that the growth of bacteria, yeasts and fungi or molds were the cause of this spoilage and potential food poisoning. During more recent decades nutritional studies have shown that while preservation is the goal the processes and ingredients used may add unwanted higher levels of carbohydrates and lack addition of desirable dietary fiber. Preservation can be accomplished by reducing the water activity (aw), shown by the abbreviation (aw), in foods being processed for storage and packaging.

### Water Activity in Food:

The water activity (aw) of a food is not the same thing as its moisture content or water content. Water content is the total amount of water in a product. Water in food which is not bound to food molecules can support the growth of bacteria, yeasts and fungi or molds. The term water activity (aw) refers to this unbound water. The water activity (aw) represents the ratio of the water vapor pressure of the unbound water of the food to the water vapor pressure of pure water under the same conditions, such as temperature, and it is expressed as a fraction.

The water activity (aw) scale extends from 0 aw (bone dry) to 1.0 aw (pure water) while most foods have a water activity (aw) level in the range of 0.2 aw for very dry foods to 0.99 aw for moist fresh foods. Water activity (aw) can also be expressed as equilibrium relative humidity (ERH). When the water activity (aw) fraction is multiplied by 100 the result obtained is the equilibrium relative humidity (ERH). The equilibrium relative humidity (ERH) is that which the foodstuff would produce if enclosed with air in a sealed container at constant temperature. Thus a food with a water activity (aw) of 0.7 aw would produce an ERH of 70%. Water activity (aw) affects the shelf life, safety, texture, flavor, and smell of foods.

### Predicting Food Spoilage:

Water activity (aw) is a useful application in predicting the growth of bacteria, yeasts and moulds. For a food to have a useful shelf life without relying on refrigerated storage, controlling either its acidity level (pH) or the level of water activity (aw) or a suitable combination of the two may be used. This can effectively increase the product's stability and make it possible to predict its shelf life under known ambient storage conditions.

Food can be made safe to store by lowering the water activity (aw) to a point that will not allow bacteria, yeasts, fungi or molds and dangerous pathogens such as Clostridium botulinum and Staphylococcus aureus to grow in it. For example a food with a water activity (aw) below 0.6 aw will not support the growth of osmophilic yeasts. Clostridium botulinum, the most dangerous food poisoning bacterium, is unable to grow at an (aw) of 0.93 aw and below. Low acid foods (pH>4.5) with a water activity (aw) greater than 0.86 aw allow the risk of food poisoning.

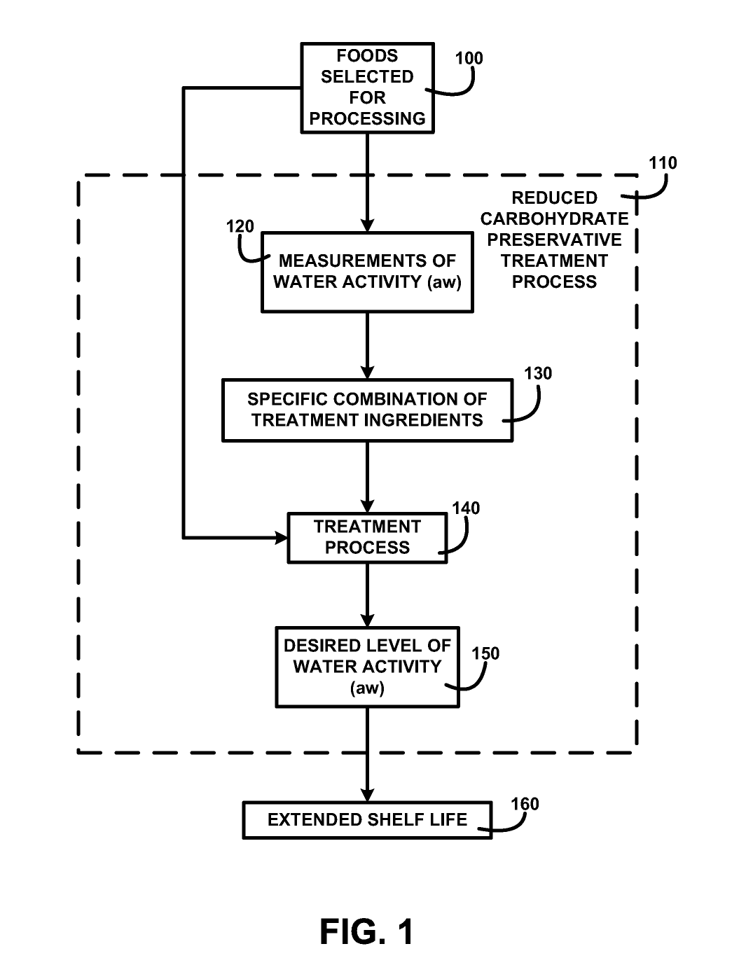

FIG. 1 shows a block diagram of an overview of an additive process for food water activity (aw) control of one embodiment of the present invention. FIG. 1 shows foods selected for processing 100. A reduced non-fiber carbohydrate preservative treatment process 110 begins by using measurements of water activity (aw) 120 for the foods selected for processing 100 to formulate a specific combination of treatment ingredients 130 that will lower the water activity (aw) of the foods selected for processing 100. A mixture of the specific combination of treatment ingredients 130 is blended with the foods selected for processing 100 through a treatment process 140 of one embodiment of the present invention.

The application of the mixture of the specific combination of treatment ingredients 130 to the foods selected for processing 100 allows reduction to a desired level of water activity (aw) 150 of the food group prior to further processing and packaging. The reduced non-fiber carbohydrate preservative treatment process 110 provides non traditional ingredients and processes to provide and predict an extended shelf life 160 to processed foods of one embodiment of the present invention.

### DETAILED OPERATION

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

### Water Activity Control Additive Combination:

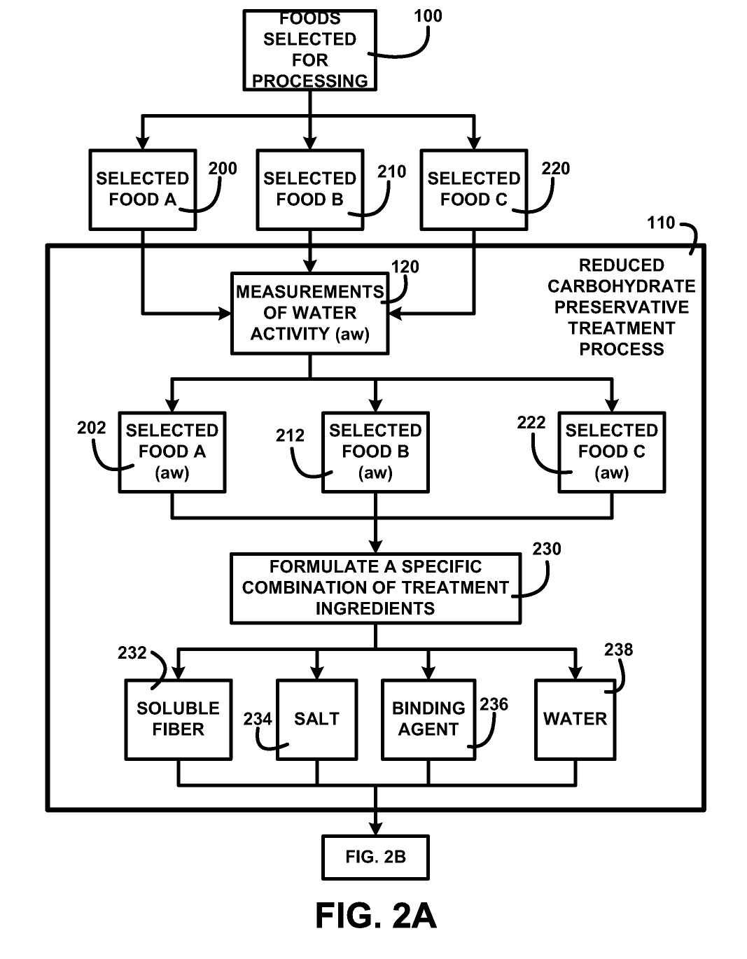

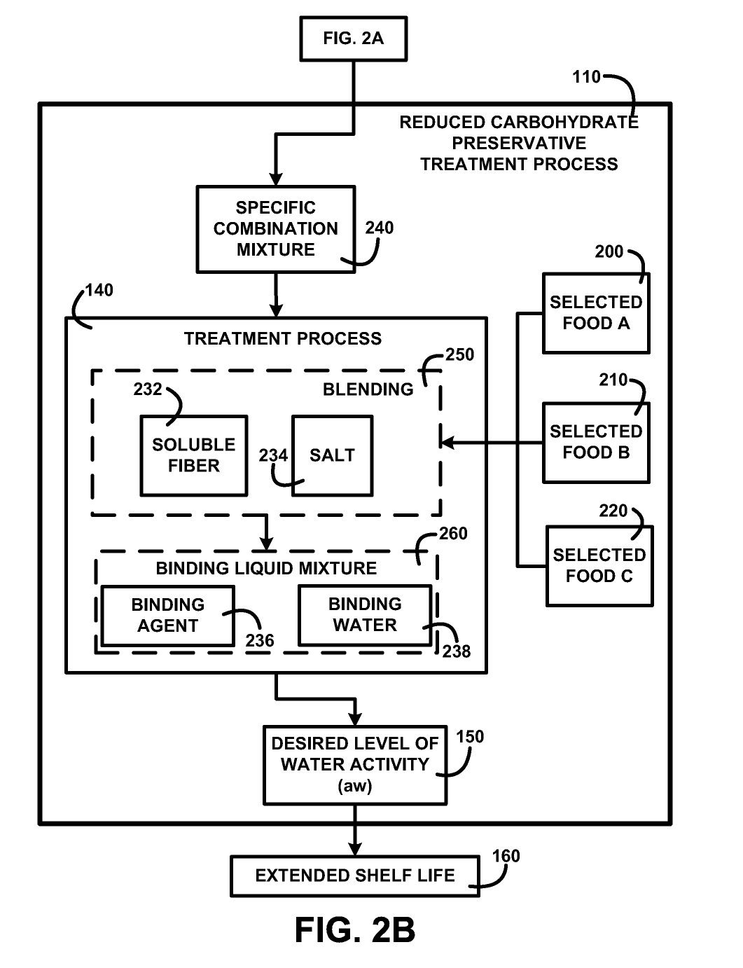

FIG. 2A shows a flow chart of an additive process for food water activity control additive combination of one embodiment of the present invention. FIG. 2A shows the foods selected for processing 100 with the reduced non-fiber carbohydrate preservative treatment process 110. Processed foods can be a single food or a combination of separate foods that have different characteristics such as texture, consistency, water content or levels of dryness, amounts of naturally occurring sugars, salts, and taste and water activity (aw). FIG. 2A includes for illustrative purposes three separate foods that will be combined into the finished product and are designated as selected food A 200, selected food B 210 and selected food C 220. Food components can be a single food or any number of food components not just three as shown in this example of one embodiment of the present invention.

Water activity (aw) 120 of the foods selected for processing 100 can be measured instrumentally. This establishes a value of the level of water activity (aw) to be controlled. In addition, values for characteristics such as taste and texture are evaluated to construct a quantitative analysis of the combined values of one embodiment of the present invention.

The reduced non-fiber carbohydrate preservative treatment process 110 uses the measurements of water activity (aw) 120 and other characteristic values to formulate a specific combination of treatment ingredients 230. The reduced non-fiber carbohydrate preservative treatment process 110 uses as additive ingredients soluble fiber 232, salt 234, binding agent 236 and water 238. The additive ingredients are combined in varying proportions to reduce water activity (aw) levels of one embodiment of the present invention.

The soluble fiber 232 and salt 234 are ingredients for the control of water activity (aw). The binding agent 236 and water 238 have a purpose in facilitating the blending of all the ingredients including the selected foods and a secondary purpose in aiding the control of water activity (aw). All four of the additive ingredients contribute to the other characteristics of the processed food such as texture and taste of one embodiment of the present invention.

Water activity (aw) is one of the major factors in determining quality and safety of processed foods. Water activity (aw) affects the shelf life, safety, texture, flavor, and smell of foods. These results of water activity (aw) make these additive ingredients ideal in controlling the levels of water activity (aw) while being adaptable to controlling taste and smell as well. Water activity (aw) can affect the textural properties of foods. Water activity (aw) is a major parameter in controlling water migration of multiple component products. Some foods contain components at different water activity (aw) levels. Different water activity (aw) levels cause moisture to migrate from a region of high aw to a region of lower aw. For example moisture migrating from a higher aw component causes the component to become hard and dry while the moisture migrating into a lower aw component causes it to become soggy of one embodiment of the present invention.

### Additive Ingredients:

### Soluble Fiber:

Soluble fiber 232 is added to the specific combination of additive ingredients in the reduced non-fiber carbohydrate preservative treatment process 110. There are three types of dietary fiber; soluble, insoluble, and resistant starch. Soluble fiber 232 dissolves in water 238 to form a gelatinous material. Some forms of soluble fiber 232 may help lower blood cholesterol and glucose levels. The specific proportion is formulated based on the measured water activity (aw) ratio, taste and texture of one embodiment of the present invention.

The additive process for food water activity control can use as the soluble fiber 232 ingredient various soluble fibers. Soluble fiber 232 for example is available in sweetness levels that range from bland to moderate sweetness. Many sources of soluble fiber 232 for example can add to the sweetness of the taste. The sweetness of soluble fiber 232 sources come from the simple sugars they contain which add to taste but these simple sugars do not add significant non-fiber carbohydrates, sugars or calories to the processed food product. Soluble fiber 232 and salt 234 can separately control water activity (aw). They can in combination control water activity (aw) effectively while being adjustable to meet desired results for taste and texture of one embodiment of the present invention.

### Salt:

Microbial growth may be stopped by adding growth inhibiting chemicals and/or substances such as salt 234. Salt 234 also is used to prevent the growth of pathogens, especially Clostridium botulinum. Salt 234 reduces the water activity (aw) in products. Salt 234, for example sea salt 234, are added to the specific combination of additive ingredients in the additive process for food water activity (aw) control. The specific proportion is formulated based on the measured water activity (aw) ratio and taste of one embodiment of the present invention.

### Binding Agent:

Soluble fiber 232 and salt 234 can be used in dry forms and a binding agent 236 acts as a cohesive binder of the dry additive ingredients to the selected foods. The binding agent 236 can be fats or oils that aid in the mixing and blending of all the ingredients in the water activity control preservative process. The binding agent 236, for example fats and oils, can have no taste to varied distinctive taste, salt contents from very low to high and sweetness levels from bland to higher sweetness. Many sources of binding agent 236 ingredients may contain for example levels of soluble fiber 232 that can add to the sweetness of the taste and therefore do not add increased carbohydrates or glucose or calories to the processed food product of one embodiment of the present invention.

### Water:

Water 238 is added to the specific combination of additives in the least amounts possible to aid in the binding of the ingredients while not negatively effecting overall moisture levels of one embodiment of the present invention.

### Specific Combination Of Additives:

The particular foods selected for processing 100 can vary individually in water activity (aw) also in salt content and sweetness. If for example the finished processed food product is to be sweet not salty to the taste and moist and firm not soggy then the combination of both the quantities and qualities of each of the additive ingredients can be adjusted. In this example the selection of the soluble fiber 232 can be one with a higher sweetness level and the quantity increased adding to the overall product sweet taste. The quantity of salt 234 can be reduced so as not to taste salty. The quantity of binding agent 236 selected can be increased with a higher sweetness level with little water content again adding to the overall product sweet taste. The amount of water 238 added for blending can be reduced to keep the finished product moist yet still firm. In this example the additive process can formulate a specific combination of treatment ingredients 230 that effectively reduce the water activity (aw) thus extending the shelf life and concurrently contribute to the desired characteristics of the finished processed food product of one embodiment of the present invention.

In this same example, if the desired characteristics of the finished processed food product are changed to be less sweet and more salty or one of the selected foods are replaced by another having different water activity (aw) and characteristics, the specific combination of additives could be adjusted to maintain control of the water activity (aw) while accommodating any changes in taste or texture. The vast numbers of possible selected foods used as product ingredients and the myriad of variations in the desired characteristics of the finished processed food product do not lend themselves to a one size fits all formulation of additive combinations. The additive ingredients used in the present invention provide the adaptability to vary the specific combinations to accommodate the variations in processed foods while providing control of the water activity (aw) and contributing to the desired characteristics of the finished processed food product. The process continues with the additive treatment in FIG. 2B of one embodiment of the present invention.

### Additive Treatment Process:

FIG. 2B shows a flow chart of an additive process for food water activity control additive treatment of one embodiment of the present invention. FIG. 2B shows a continuation of the reduced non-fiber carbohydrate preservative treatment process 110 from FIG. 2A in which the specific combination of additive ingredients was formulated to create a specific combination mixture 240. The specific combination mixture 240 is mixed with selected food A 200, selected food B 210 and selected food C 220 in a treatment process 140. The treatment process 140 is the blending 250 of the additive ingredients soluble fiber 232 and salt 234 from the specific combination mixture 240 with the foods selected for processing 100 of FIG. 1. The treatment process 140 proceeds with the blending 250 by adding the binding liquid mixture 260 comprised of the binding agent 236 and water 238. Once the treatment process 140 is completed for example measurements of water activity (aw) 120 or periodic measurements of water activity (aw) 120 over varying periods of time can be performed of the finished product to confirm the desired level of water activity (aw) 150 has been obtained to produce and predict the extended shelf life 160 of one embodiment of the present invention.

The treatment process 140 can be varied to accommodate the different food components of the foods selected for processing 100 of FIG. 1 and the form of additive ingredients. The treatment process 140 can for example be a dry process in which dry additive ingredients and the dry foods selected for processing 100 of FIG. 1 can be mixed together. Another treatment process 140 for example can be infusion of liquid forms of the additive ingredients with moist foods selected for processing 100 of FIG. 1. The condition of the foods selected for processing 100 of FIG. 1 for example may be more suited to a combination of dry and liquid infusion processes of one embodiment of the present invention.

The additive treatment process 140 can be sequenced, for example, where dry powdered soluble fiber 232 and granulated salt 234 are mixed with the dry food components. The additive treatment process 140 proceeds by blending 250 into the mixture the binding agent 236 in liquid form and water 238 is added for binding all of the additive ingredients and food components according to the desired texture. Another variation of the treatment process 140 for example can be to mix all the additive ingredients, soluble fiber 232, granulated salt 234; liquid binding agent 236 and water 238, together then blend the additive combination liquid mixture with the food components of one embodiment of the present invention.

### Extended Shelf Life:

The desired level of water activity (aw) 150 and the extended shelf life 160 depend upon the type of processed food product, packaging and the desired shelf life. Water activity (aw) is a measure of the water available for microbial growth. Acceptable water activity (aw) levels depends on the packaging and type of post processing storage to be used and the length of storage time desired for the processed food of the present invention.

Post processing storage for example of moist foods with water activity (aw) above 0.85 aw requires refrigeration or another barrier to control growth of pathogens. Intermediate moisture foods with water activity (aw) levels ranging from 0.60 aw to 0.85 aw does not require refrigeration to control pathogens also have limited shelf life because of spoilage, primarily by yeasts and molds. Low moisture foods with water activity (aw) below 0.60 aw can have extended shelf life without refrigeration of the present invention.

The reduced non-fiber carbohydrate preservative treatment process 110 uses additive ingredients that can be easily adjusted to produce the desired level of water activity (aw) 150 for example 0.70 and below without significantly increased non-fiber carbohydrates or sugars. The reduced levels of water activity (aw) can produce an extended shelf life of one year or more. The adjustments allow both the specific combination mixture 240 and treatment process 140 to suit the variations of the foods selected for processing 100 of FIG. 1. The reduced non-fiber carbohydrate preservative treatment process 110 provides effective control of water activity (aw) and contributes to the desired taste and texture leading to quality processed food products with extended shelf life 160 without significantly increasing non-fiber carbohydrates or sugars of one embodiment of the present invention.

### Nutrition/Protein Bars:

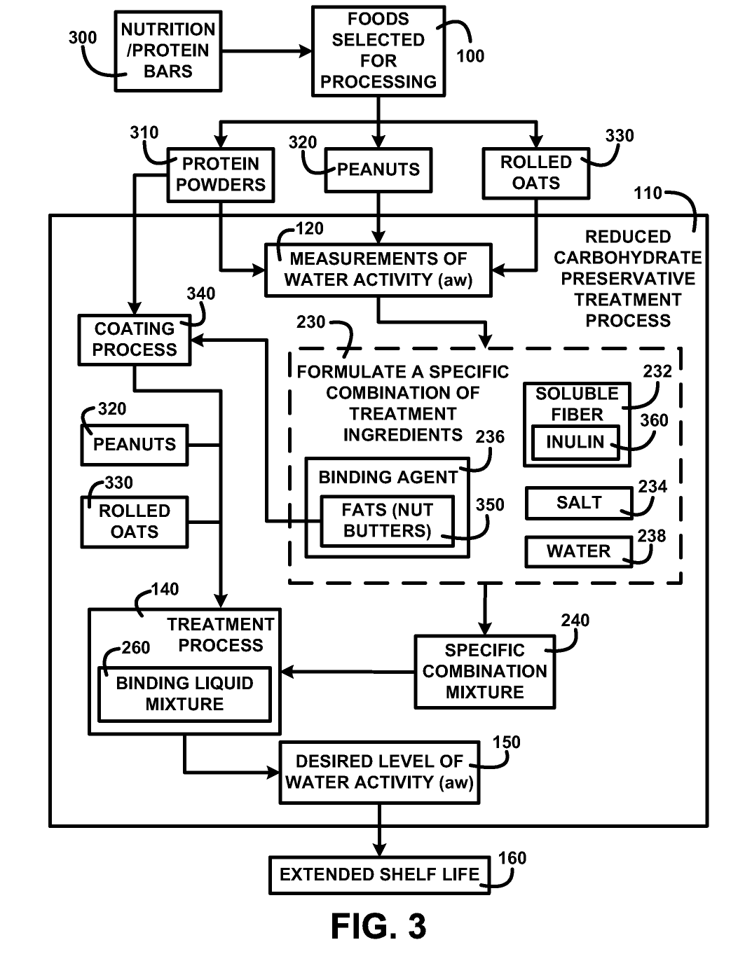

FIG. 3 shows for illustrative purposes only an example of the additive process for food water activity control applied to processing nutrition/protein bars of one embodiment of the present invention. FIG. 3 shows an example of the application of the reduced non-fiber carbohydrate preservative treatment process 110 to the processing of nutrition/protein bars 300. The foods selected for processing 100 of nutrition/protein bars 300 can be for example food components that provide nutritional values intended to improve the health of the consumer. Using ingredients to control water activity (aw) such as sugar, high fructose corn syrup, glycerin and brown rice syrup result in nutrition/protein bars 300 that contain high levels of non-fiber carbohydrates which may not have healthy effects. The reduced non-fiber carbohydrate preservative treatment process 110 uses additive ingredients that while controlling water activity (aw) do not significantly increase the levels of non-fiber carbohydrates in the finished processed food product for example nutrition/protein bars 300 of one embodiment of the present invention.

The example illustrated in FIG. 3 shows the foods selected for processing 100 of nutrition/protein bars 300 including protein powders 310, peanuts 320 and rolled oats 330, but preferably without adding non-fiber substances that typically increase carbohydrate, sugar and calorie content of the food. These non-fiber substances usually include corn syrups and the like. The reduced non-fiber carbohydrate preservative treatment process 110 begins with the measurement of water activity (aw) 120 of these food components. Without any or adequate water activity (aw) control the nutrition/protein bars 300 will have a reduced shelf life and the bars will mold within a few days to a few months of one embodiment of the present invention.

The reduced non-fiber carbohydrate preservative treatment process 110 proceeds to formulate a specific combination of treatment ingredients 230 to provide effective water activity (aw) control. The specific proportions of the additive ingredients to be combined are formulated based on the measured water activity (aw) ratio, taste and texture. The additive ingredients used in this example are soluble fiber 232, such as inulin 360, which can be in a powdered form or liquid form, salt 234, such as granulated sea salt, water 238, and the binding agent 236, such as fats (nut butters) 350. The water activity (aw) dry additive ingredients are mixed together first to ensure proper blending of the inulin 360 and salt 234 of one embodiment of the present invention.

The additive process can include for example a coating process 340 which is used to coat the protein powders 310 with the fats (nut butters) 350 binding agent 236. This coating process 340 can reduce the quantity of water 238 in the additive combination. The coated or uncoated protein powders 310, peanuts 320, rolled oats 330 and the specific combination mixture 240 of additive ingredients are blended in the treatment process 140. The dry foods selected for processing 100 and dry additive ingredients are mixed first to allow thorough blending. The binding liquid mixture 260 is added to allow the forming of the blended ingredients into the nutrition/protein bars 300 bar shape. A measurement of water activity (aw) 120 following the reduced non-fiber carbohydrate preservative treatment process 110 shows the resulting approximate desired level of water activity (aw) 150 of 0.6 aw to 0.8 aw in one embodiment of the present invention.

There are four factors that determine shelf life: water activity (aw) controls additive formulation, processing, packaging and storage. Packaging and storage would have an impact on the shelf life. Standard packaging and outside of unusual conditions (storage in hot or sunny conditions, etc.) the exampled nutrition/protein bars 300 can for example have an extended shelf life 160 of one year or more. In the FIG. 3 example if the peanuts 320 are dry roasted or salted the specific combination of additive ingredients would change to adjust to those particular conditions as the measure of water activity (aw) and salt content would change. In the FIG. 3 example if the rolled oats 330 are replaced by rice crisps the specific combination of additive ingredients would change to adjust to those particular conditions as the measure of water activity (aw) and texture requirements would change of one embodiment of the present invention.

### Soluble Fibers:

Soluble fibers can include polydextrose, vegetable gums (gum acacia, guar gum, etc.). The inulin 360 is also a soluble fiber 232 that can be used in one embodiment to replace sugar, fat, and flour in the control of water activity (aw) in the present invention. Inulin is generally recognized as safe by the U.S. Food and Drug Administration (FDA). Inulin 360 is a group of naturally occurring polysaccharides; several simple sugars linked together, and are produced by many types of plants. Some natural plants that contain high concentrations of inulin include for example chicory root, dandelion, wild yam, Jerusalem artichokes, jicama, onion, garlic and agave of one embodiment of the present invention.

Inulin belongs to a class of fibers known as fructans. Inulin is used by some plants as a means of storing energy and is typically found in roots or rhizomes. Most plants that synthesize and store inulin do not store other materials such as starch which contain high levels of glucose sugars. Commercially available inulin 360 is produced with flavor ranges from bland to subtly sweet. The sweetness of inulin can range from 10% to 50% of the sweetness of a sucrose solution of the same concentration equaling 100%. As an additive it comes in both a dry powder and as syrup of one embodiment of the present invention.

Inulin 360 resists digestion because of the bonds holding its sugar molecules together. Inulin 360 has a minimal impact on blood sugar and does not raise triglycerides, making it generally considered suitable for diabetics and potentially helpful in managing blood sugar-related illnesses of one embodiment of the present invention.

Inulin 360 also has other health benefits. Inulin 360 increases calcium absorption and possibly magnesium absorption. Inulin 360 also stimulates the growth of bacteria in the gut. Inulin passes through the stomach and duodenum undigested and is highly available to the gut bacterial flora. Soluble fiber 232 such as inulin 360 as an additive ingredient in the reduced non-fiber carbohydrate preservative treatment process 110 provides an adaptable means to reduce and control water activity (aw) to extend shelf life and to meet consumer demands of taste and texture in processed foods without adding significantly to non-fiber carbohydrate, sugar or calorie content of one embodiment of the present invention.

### Nut Butter:

The reduced non-fiber carbohydrate preservative treatment process 110 uses for example fats (nut butters) 350 as an additive ingredient to act as a binding agent 236. Nut butters are a spreadable foodstuff made by crushing nuts that for example can be raw, have been roasted in oil or dry roasted. The result has a high fat content and can be spread like true butter, yet is otherwise unrelated to true butter as nut butters are a non dairy product of one embodiment of the present invention.

Nut butters can be made from base ingredients that include true nuts in a botanical sense for example hazelnuts and pecans. Nut butters can also be made from base ingredients which are for example botanically classified as fruits or seeds while considered nuts in a culinary sense such as almonds, walnuts, peanuts, pistachios, pumpkin seeds and sunflower seeds. Nut butters are high in protein, nutrients, and low in sugars. The nutrients include soluble fiber 232, multiple antioxidants such as vitamin E, copper, potassium, B vitamins, Calcium and Zinc and many more of one embodiment of the present invention.

The reduced non-fiber carbohydrate preservative treatment process 110 uses non traditional combinations of soluble fiber 232, salt 234, binding agent 236 and water 238 as water activity (aw) control additive ingredients. Adjustability in formulating the specific combination of water activity (aw) control additive ingredients and treatment processing provide an effective process to preserve processed foods to extend the shelf life, reduce the amount of non-fiber carbohydrates and reduce the sugar content of the finished processed food products of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method for reduced non-fiber carbohydrate preservative treatment of processed foods to control water activity to extend the shelf life, comprising:
combining reduced non-fiber carbohydrate preservative treatment ingredients including a soluble fiber such as inulin, a salt, a binding agent such as fats or nut butters and water;
formulating specific combination portions of reduced non-fiber carbohydrate preservative treatment ingredients based on measurements of water activity in the foods selected for processing;
mixing the combination of reduced non-fiber carbohydrate preservative treatment ingredients; and
treating the foods selected for processing with the mixture of reduced non-fiber carbohydrate preservative treatment ingredients in an additive process to control water activity without adding significant non-fiber carbohydrates or glucose or calories and extend the shelf life of the processed food product to one year or more.

2. The method of claim 1, wherein the reduced non-fiber carbohydrate preservative treatment ingredients comprise at least a combination of a soluble fiber such as inulin and a salt to control water activity.

3. The method of claim 1, wherein the reduced non-fiber carbohydrate preservative treatment ingredients include a soluble fiber such as inulin which can act as a taste sweetness modifier and therefore do not add significant non-fiber carbohydrates, glucose or calories to the processed food product.

4. The method of claim 1, wherein the reduced non-fiber carbohydrate preservative treatment ingredients can include a binding agent such as fats or nut butters which can contain soluble fiber which can act as a taste sweetness modifier and therefore do not add significant non-fiber carbohydrates, glucose or calories to the processed food product.

5. The method of claim 1, wherein the results of the measurement of water activity in the foods selected for processing are used to quantify the specific combination portions of the reduced non-fiber carbohydrate preservative treatment ingredients to produce the desired level of water activity in the processed food product.

6. The method of claim 1, wherein the specific characteristics of all of the ingredients such as dry, moist or liquid are used to determine the methods of treatment to provide thorough blending of all the ingredients.

7. A reduced non-fiber carbohydrate preservative treatment mixture, comprising:
a soluble fiber treatment mixture ingredient is used to control water activity and which can act as a taste sweetness modifier and therefore do not add significant non-fiber carbohydrates, glucose or calories to the processed food product;
a salt treatment mixture ingredient is used to control water activity and which acts as a taste modifier;
a binding agent treatment mixture ingredient is used which acts to bind the ingredients and which can act as a texture modifier;
a water treatment mixture ingredient which acts to bind the ingredients and adjust moisture levels and which can act as a texture modifier; and
a formulated combination of the soluble fiber, the salt, the binding agent and the water ingredients which form a reduced non-fiber carbohydrate preservative mixture to be used for the treatment of processed food products in an additive process to control water activity without adding significant non-fiber carbohydrates or glucose or calories and extend the shelf life of the processed food product to one year or more.

8. The reduced non-fiber carbohydrate preservative treatment mixture of claim 7, wherein inulin is a soluble fiber and can be used to control water activity (aw) of the processed food product.

9. The reduced non-fiber carbohydrate preservative treatment mixture of claim 7, wherein inulin ingredients used can be produced at various sweetness levels and which can act as a taste modifier and therefore do not add significant non-fiber carbohydrates, glucose or calories to the processed food product.

10. The reduced non-fiber carbohydrate preservative treatment mixture of claim 7, wherein the treatment ingredient mixture produced using a specific combination of at least the soluble fiber ingredient such as inulin and the salt ingredient can be used to control water activity to extend shelf life to one year or more and which does not add significant non-fiber carbohydrates or glucose or calories to the processed food product.

11. The reduced non-fiber carbohydrate preservative treatment mixture of claim 7, wherein a salt ingredient such as sea salt can be used to control water activity (aw) to extend shelf life of the processed food product.

12. The reduced non-fiber carbohydrate preservative treatment mixture of claim 7, wherein fats in the form of nut butters can be used to blend all ingredients and act as the binding agent of the processed food product.

13. The reduced non-fiber carbohydrate preservative treatment mixture of claim 12, wherein the nut butters can be made from nuts, fruits and seeds and which can act as a taste modifier of the processed food product.

14. The reduced non-fiber carbohydrate preservative treatment mixture of claim 12, wherein the nut butters contain soluble fiber and can be used to control water activity (aw) to extend shelf life of the processed food product.

15. The reduced non-fiber carbohydrate preservative treatment mixture of claim 7, wherein the proportion of water in the formulated combination can be used to adjust the moisture level of the processed food product.

16. A method for reduced non-fiber carbohydrate preservative treatment of nutrition/protein bar food products to extend the shelf life, comprising:
combining reduced non-fiber carbohydrate preservative treatment ingredients including a soluble fiber such as inulin, a salt, a binding agent such as fats or nut butters and water;
formulating a combination of multiple reduced non-fiber carbohydrate preservative treatment ingredients based on the measurements of water activity in the nutrition/protein bar ingredients selected for processing;
mixing the combination of multiple reduced non-fiber carbohydrate preservative treatment ingredients; and
treating the nutrition/protein bar ingredients selected for processing with the mixture of multiple reduced non-fiber carbohydrate preservative treatment ingredients.

17. The method of claim 16, wherein the reduced non-fiber carbohydrate preservative treatment ingredients comprise at least a combination of a soluble fiber such as inulin and a salt to control water activity to 0.70 aw or less in the nutrition/protein bar food products to extend the shelf life to one year or more.

18. The method of claim 16, wherein the soluble fiber ingredient such as inulin which is a soluble fiber and can be used to control water activity (aw) and which can act as a taste modifier.

19. The method of claim 16, wherein reduced non-fiber carbohydrate preservative treatment ingredients include a binding agent ingredient such as fats in the form of nut butters which can be made from nuts, fruits and seeds and which can act as a taste modifier and which can contain soluble fiber and can be used to control water activity to extend shelf life.

20. The method of claim 16, wherein protein powders used as a nutrition/protein bar ingredient can be coated with a binding agent ingredient such as nut butters to allow reduction in the quantity of water in the formulated combination of reduced non-fiber carbohydrate preservative treatment ingredients.
